(19) United States
(12) Patent Application Publication
(10) Pub. No.: US 2016/0261490 A1
(43) Pub. Date: Sep. 8, 2016

(54) BONDING ROUTER

(71) Applicant: SHARED BAND LIMITED, Ipswich (GB)

(72) Inventor: Paul Andrew Evans, Ipswich, Suffolk (GB)

(21) Appl. No.: 15/032,714

(22) PCT Filed: Oct. 31, 2014
(86) PCT No.: PCT/GB2014/053249

§ 371 Date: Apr. 28, 2016

(30) Foreign Application Priority Data
Nov. 1, 2013 (GB) 1319378.4

(51) Int. Cl. H04L 12/709; H04L 12/28; H04L 12/24; H04L 12/741; H04L 29/12; H04L 29/08

(52) U.S. Cl. CPC H04L 45/245; H04L 61/6022; H04L 61/2038; H04L 69/329; H04L 41/0226; H04L 45/745; H04L 61/2015; H04L 61/103; H04L 12/2834; H04L 12/2898; H04W 88/16

(57) ABSTRACT

This invention relates to providing a bonded broadband router for customer premises. The invention provides an apparatus and method for receiving packets from a local area network and sending them over an aggregated link comprising one or more communication links. The local area network has a default router and devices in the local area network have previously been configured to communicate with said default router using a network address associated with said default router. The bonding router is arranged to obtain the network address of said default router and is arranged to regularly transmit a message to devices within said local area network to cause said devices to associate the network address of the default router with the link layer address of the bonding router such that data sent by said devices containing the network address of the default router will instead be directed to the bonding router.

### BACKGROUND

a. Field of the Invention

This invention relates to providing a bonded broadband router for customer premises. Broadband bonding refers to the aggregation of broadband channels such as multiple fixed and or/wireless channels to provide an aggregated channel with a corresponding higher bandwidth.

In this description reference is made to the OSI seven layer protocol stack summarised briefly in the table below. The terms packets and datagrams are used interchangeably in this description.

| Layer | Name | Function |
|---|---|---|
| 1. | Physical | A not necessarily reliable direct point-to-point data |
| | | connection. |
| 2. | Data link | A reliable direct point-to-point data connection. |
| 3. | Network | Addressing, routing and not necessarily reliable |
| | | delivery of datagrams/packets between points on a |
| | | network. |
| 4. | Transport | Reliable delivery of datagrams/packets between |
| | | points on a network. |
| 5. | Session | Interhost communication, managing sessions |
| | | between applications |
| 6. | Presentation | Data representation, encryption and decryption, |
| | | convert machine dependent data to machine |
| | | independent data |
| 7. | Application | Network process to application |

b. Related Art

In order to introduce bonding capability to an existing local area network at a customer premises, there are two possibilities. The first is to replace a customer's existing router with a bonding router, the second is to add an additional bonding routing device to the local area network which does the bonding.

Bonding in various forms has been available since the early 1980s. However no bonding service provider has to date been able to provide a ‘plug & play’ solution to supplying a bonding router to an existing customer local area network without significant reconfiguration effort.

When providing a bonding router to customer premises it is necessary to configure existing devices to address the bonding router ie to explicitly change configuration of all devices on the customer's Local Area Network to point to the bonding router.

Bonding routers for businesses are typically large devices with multiple WAN interfaces that are invasive i.e. businesses insert the device into their network, and need to re-configure all of their LAN devices (PCs, firewalls, iPads) to point to the bonding device as the default gateway. Because of the business imperative, coupled with the fact many companies have an IT department or external consultant, this is an acceptable overhead and one that many businesses accept.

For residential customers this can be a real problem and requires significant effort.

A number of companies are looking to move bonding into the residential space whereby residential customers can supplement the capacity of their home Broadband with the capacity of mobile (3G/4G). This is very much seen as a solution to those customers who cannot get fibre optic Internet, or cable Broadband. Because of the re-configuration effort mentioned above, many vendors have ruled out an ‘add on’ box, and have chosen to replace the customer's primary router with a new one, that incorporates a new DSL modem, Wi-Fi access point and LTE modem. The cost of this new piece of equipment can cost in excess of $200.

However, if an additional bonding routing device to the local area network can be added to the customer network to do the bonding then it is possible to re-use the customer's existing DSL modem, Wi-Fi access point and the 3G/4G modem in their smartphone, meaning costs can drop to $12 or less.

By having an additional, plug and play bonding box that plugs into the back of an existing DSL gateway, that needs no re-configuration of the vast majority of devices on the customer's LAN, the commercial potential of residential DSL/cellular bonding is substantially greater.

U.S. Pat. No. 7,567,573 discloses a technique for connecting New Network Devices (NNDs) to an existing communication network.

The NND caches the MAC address of an Original (or “Old”) Network Device, then transmits Address Resolution Protocol (ARP) responses on behalf of the OND, after receiving ‘who-has’ ARP request from network devices but pointing to its own MAC address.

This, allows the NND to insert itself in the path of packets originally destined for the OND. After performing designated operations such as filtering, compression, caching, file serving, virus scanning, etc., any remaining packets are forwarded to the OND for further processing.

In U.S. Pat. No. 7,567,573 the NND sends ARP messages in response to ARP messages destined for the OND as well as those originating from the OND. A problem with this approach is that devices that already have the link layer address of the OND in their cache will simply continue to route packets to the old network device as there is no need for them to broadcast and ARP request. Until a device somewhere transmits an ARP request resulting in a ‘spoof’ ARP response from the NND the local caches on existing devices will not be updated.

Furthermore, one of the key differences is the NND is responding when somebody issues a request. This causes a race condition because the OND could in fact respond before the NND has the chance. It will work some of the time, but not consistently.

US patent application No 2012/0213094 discloses a method of configuring an appliance to be a plug-and-play network filter by altering the flow of network traffic when the appliance is connected to a network. The appliance establishes itself between the router and end user terminals and is configured to respond to any ARP Request on the Gateway IP address. In this particular application the appliance effectively intercepts and monitors Internet traffic, and filter certain predefined types of Internet traffic.

In both of these prior art disclosures a ‘spoofing’ device is inserted into a network to intercept traffic destined for an existing device by means of ARP ‘spoof’ messages claiming the link layer address for the existing network device. After performing certain functions, such as filtering, compression, caching, file serving, virus scanning, etc. the spoofing device then forwards the traffic to the existing device for routing to the outside world via the Internet. The spoofing device does not forward traffic directly to the Internet itself and does not have any bonding functionality.

There is a requirement for a bonding solution which is quick and simple to install and which does not require reprogramming/reconfiguring numerous devices due to the introduction of a bonding routing device and which does not suffer from the problems mention above in relation to the methods described in the prior art.

### SUMMARY OF THE INVENTION

According to the invention there is provided a bonding router for receiving packets from a local area network and sending them over an aggregated link comprising one or more communication links in which the local area network has a default router and devices in the local area network have previously been configured to communicate with said default router using a network address associated with said default router; the bonding router is arranged to obtain the network address of said default router and is arranged to regularly transmit a message to devices within said local area network to cause said devices to associate the network address of the default router with the link layer address of the bonding router such that data sent by said devices containing the network address of the default router will instead be directed to the bonding router.

According to another aspect of the invention there is provided a method of installing a bonding router in a local area network in which the local area network has a default router and devices in the local area network have previously been configured to communicate with said default router using a network address associated with said default router, the method comprising the steps of: connecting the bonding router to the local area network; obtaining the network address of the default router; and regularly transmitting a message to devices within said local area network to cause said devices to associate the network address of the default router with the link layer address of the bonding router.

Preferably a static entry in an address translation table is created in the bonding router associating the network address of the default router with the link layer address of the bonding router.

The network address may be an IP address. The link layer address may be a MAC address. The network address of the default router may be obtained using DHCP. The message may advantageously comprises an ARP message.

### BRIEF DESCRIPTION OF THE DRAWINGS

The invention will now be described, by way of example only, with reference to the accompanying drawings, in which

FIG. 1 illustrates a device using broadband bonding;

FIG. 2 illustrates a typical customer local area network;

FIG. 3 illustrates a simplified example of a home network in normal operation;

FIG. 4 illustrates the network of FIG. 2 with an additional bonding router;

FIG. 5 is a flow chart illustrating the steps in installing and configuring a bonding router; and

FIG. 6 illustrates a bonding router and home gateway router connected to the Internet in accordance with the present invention.

### DETAILED DESCRIPTION

Broadband bonding is used to combine the upstream and downstream capacity of multiple connections into a single virtual connection. For example two 2 Mbps download, 250 kbps upload Digital Subscriber Lines (DSLs) could be combined to provide up to a 4 Mbps download, 500 kbps upload connection.

The terms ‘devices’ and ‘stations’ are used interchangeably throughout the following description.

The term DSL may refer to any type of digital subscriber line for example Asymmetric DSL, Symmetric DSL, High bit rate DSL etc.

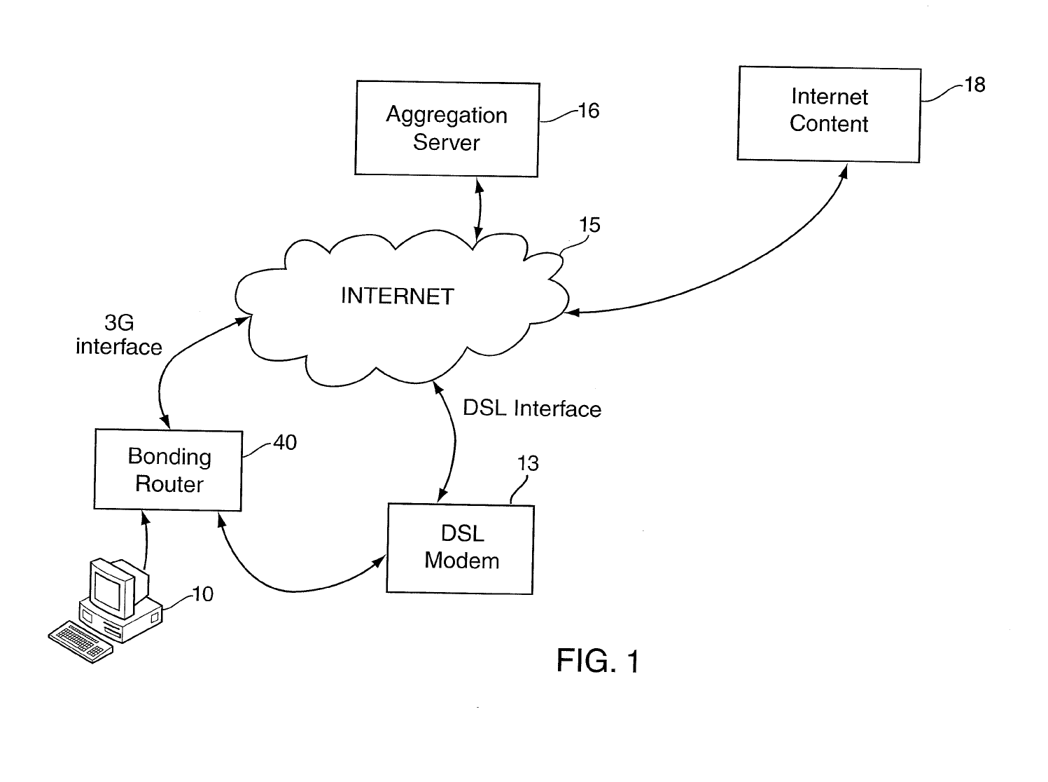

FIG. 1 illustrates a network using broadband bonding. Broadband bonding seamlessly combines multiple broadband pipes into single virtual pipe and can use almost any physical layer connection type such as Digital Subscriber Lines (DSLs), cable, satellite, Bell Labs Transmission System 1 (T1), mobile broadband (3G/4G) to name but a few. A customer local area network device 10 connects to a communications network (e.g. the Internet) 15 via a bonding enabled router 40, which in practice are provided by a firmware upgrade to low-cost commodity routers from standard providers such as Linksys, D-Link or Netgear. For example, the device 10 may connect to the Internet via bonding enabled router 40 and digital subscriber line (DSL) modem 13 or via a 3G interface. Upload and download data is sent via an aggregation server 16 which provides the public IP address and compensates for different line speeds and latencies. Internet content server 18 is also illustrated.

Broadband bonding can operate in a number of different modes: In simple bonding mode the capacity of multiple lines is combined into a single virtual connection; in failover mode multiple lines are bonded onto a single virtual connection but if they fail traffic is seamlessly routed over a backup line; in overflow/speed boost mode a second line is only used when the primary is full and/or there is an application need.

In simple bonding mode packets are distributed over the multiple connections based upon the relative speeds of the connection. For example connections with an equal speed would have an equal number of packets sent over each connection, however one 3 Mbps connection will have three times the packets sent to it as compared to a 1 Mbps connection.

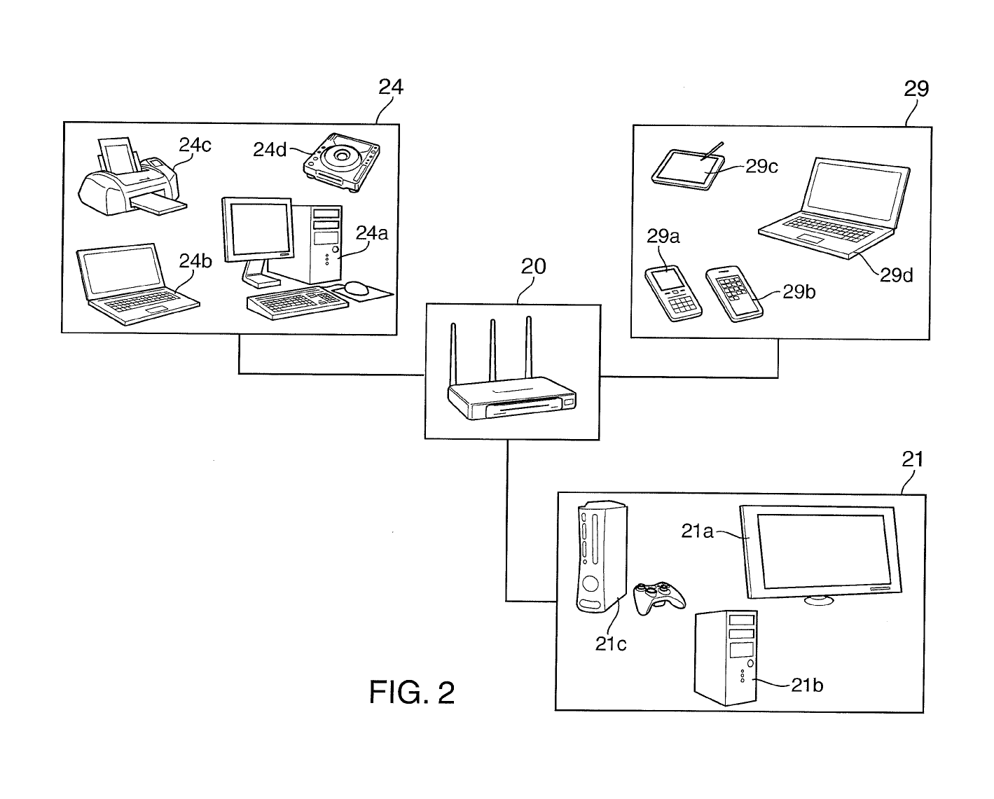

A typical home network comprising a plurality of customer local area network devices is illustrated in FIG. 2. Data is received from the communications network via a router 20. The router 20 which may be a wired router or a wireless router or both, serves one or more clusters of devices, for example an entertainment cluster 21 may comprise a television display 21a, associated home theatre PC 21b and games console 21c. A home office cluster 24 may comprise one or more desktop PCs 24a, or laptop PCs 24b, together with printers 24c and storage devices 24d. Wireless devices 29 may include music playing devices such as iPod™ 29a, smartphones 29b, tablets 29c or wireless PCs 29d to name but a few.

The Address Resolution Protocol (ARP), is used to map network-layer addresses, for example an Internet Protocol (IP) address, to a link-layer address, for example a media access control (MAC) address.

When data is set over a network from a transmitting station to a receiving station a network layer packet is created with an appropriate network layer destination address (for example an IP destination address).

This packet is passed to the link-layer, for example Ethernet which needs to encapsulate the network layer packet into a link-layer packet before it can be sent. Therefore, a mapping is required between the network address and the link-layer address and this is usually implemented by maintaining a lookup table in a local cache on each station in the network.

If the network address for the required receiving station is not available in the transmitting station's local cache the transmitting station must find out what the link-layer address is for the receiving station.

The transmitting station broadcasts an ARP request message to all stations on the local subnetwork which says tell me who is responsible for the required destination address (sometimes referred to as a ‘who-has’ message). The ARP request also contains the network layer and link layer address of the transmitting station.

All stations on the subnetwork receiving the ARP request will do two things:

a) add the transmitting station's network and link layer address mapping to their own local cache;
b) if they are responsible for the required destination address they will respond with a ARP reply stating the relevant link layer address associated with the destination address.

An ARP announcement message may be transmitted (or broadcast) by any station to claim ownership of a particular link layer address. When a gratuitous (or unsolicited) ARP announcement is transmitted by any station containing the network layer and link layer address of the transmitting station all stations on the subnetwork receiving the ARP announcement will simply add the transmitting station's network and link layer address mapping to their own local cache.

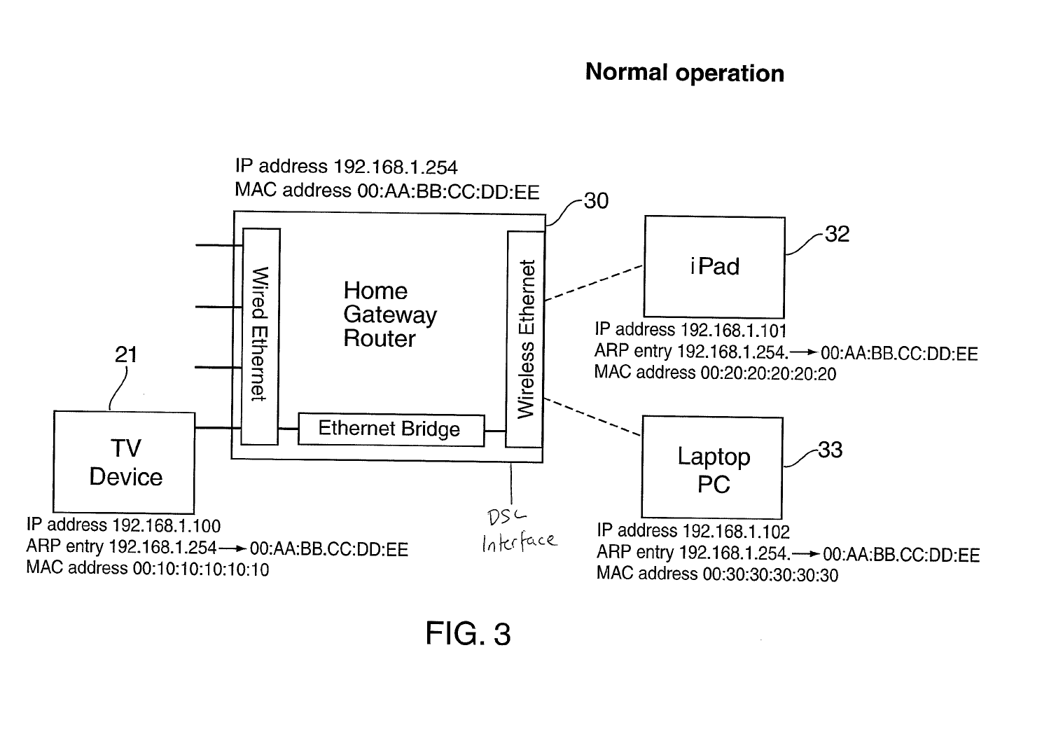

FIG. 3 illustrates a simplified example of a home network similar to that shown in FIG. 2 comprising a router 30 with DSL interface, a TV device 21 and iPad™ 32 and a Laptop PC 33. The router 30 has Ethernet switch segments for both wired and wireless Ethernet which are seamlessly connected through an Ethernet bridge.

Each station has both an IP address and a MAC address as shown in the Figure. Each device on the home network maintains an ARP look up table in its local cache. So in the example shown The router 30 has an IP address of 192.168.1.254 and a MAC address of 00:AA:BB:CC:DD:EE. Each station has an entry in its ARP table mapping IP address 192.168.1.254 to MAC address 00:AA:BB:CC:DD:EE.

Because a transmitting station always consults its own cache before asking other stations who is responsible for a particular network layer address, it is possible to take control of a particular network layer address by making sure that a particular link layer address associated with that network layer address is always present in the local cache of all stations. This can be achieved by sending out ‘spoof’ ARP announcements containing the network layer address that it is desired to control and the link layer address of the device that wishes to control that network destination address. The can equally be achieved by send out ARP requests containing the network layer address that it is desired to control and the link layer address of the device that wishes to control that network destination address.

Therefore it is possible to install a bonding router in a customer's premises where the bonding router is arranged to send ‘spoof’ ARP announcements or requests claiming that its own link layer address (MAC address) is responsible for the network layer address of the router that all the other devices had previously been configured to route through.

All of the stations duly update their local cache, and therefore any packets destined for the original default router are redirected to the newly installed bonding router instead, with no reconfiguration or reprogramming required.

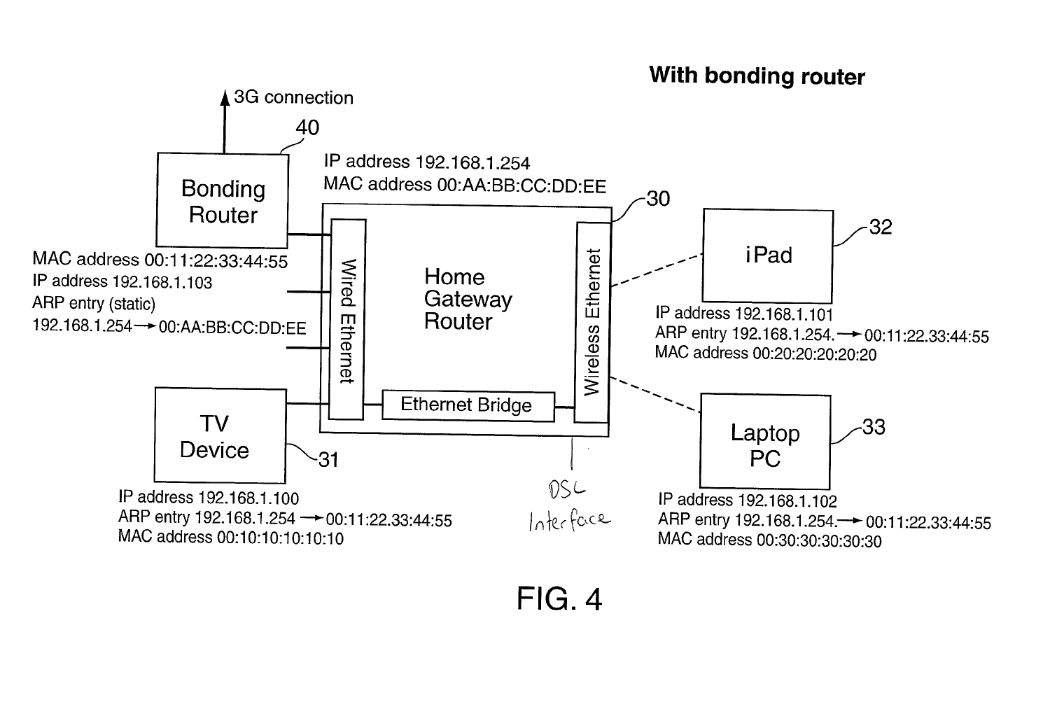

FIG. 4 shows the network of FIG. 2 with an additional bonding router 40. The bonding router has IP address of 192.168.1.103 and a MAC address of 00:11:22:33:44:55. The bonding router 40 has a static entry in its ARP table mapping IP address 192.168.1.254 to MAC address 00:AA:BB:CC:DD:EE obtained using Dynamic Host Configuration Protocol (DHCP). The bonding router sends an ARP announcement claiming that its own MAC address 00:11:22:33:44:55 is responsible for the IP address 192.168.1.254 of the original home gateway router 30. Therefore each station updates their ARP table as shown so that each station now has an entry in its ARP table mapping IP address 192.168.1.254 to MAC address 00:11:22:33:44:55.

Within a fraction of a second all devices on the network will automatically send data to the bonding router 40 rather than to the router 30 to which the data would previously been directed. The ‘spoof’ ARP announcement message is sent every 0.2 s so that even if the original router 30 broadcasts a message reclaiming ownership of that network layer address, it is quickly changed back to that of bonding router.

By pro-actively instructing all the devices to update their ARP caches, this method eliminates the need for devices to submit a ‘who-has’ request in the first place. Thus ensuring that the ‘intervention’ process is far more consistent and avoids the race condition which in inherent in the prior art approaches.

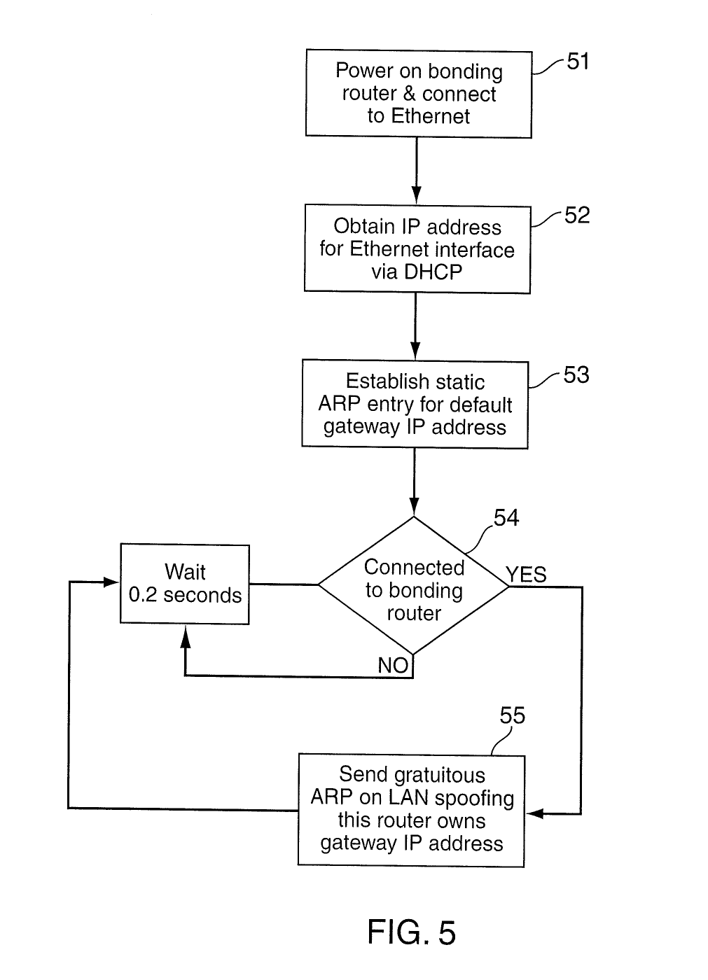

FIG. 5 is a flow chart illustrating the steps in installing and configuring the bonding router 40. At step 51 the bonding router 40 is turned on and connected to the Internet. An IP address for the default Ethernet switch is obtained via DHCP at step 52. At step 53 a static (ie permanent) ARP table entry is established for the default router IP address within the bonding router's ARP table. Then while the bonding router 40 is connected to the network at step 54 a gratuitous ARP message is sent at step 55 claiming that its own link layer address (MAC address 00:11:22:33:44:55 in the example shown in FIG. 4) is responsible for the network layer address (IP address 192.168.1.254 in the example shown in FIG. 4) of the router 30 that all of the devices on the network are currently directed to.

Because of the gratuitous ARP messages, updating the MAC address to IP address tables on devices, this typically prevents the devices from performing normal ARP operations on the default router's network layer address i.e. it prevents them ever needing to ask which link layer address address is responsible for the default router network address.

The bonding router does not interfere with the DHCP mechanism, because when a device broadcasts a message asking for an IP address the original DHCP server will detect the message and respond appropriately. Therefore previously defined DHCP IP ranges IP address pools etc will not be affected.

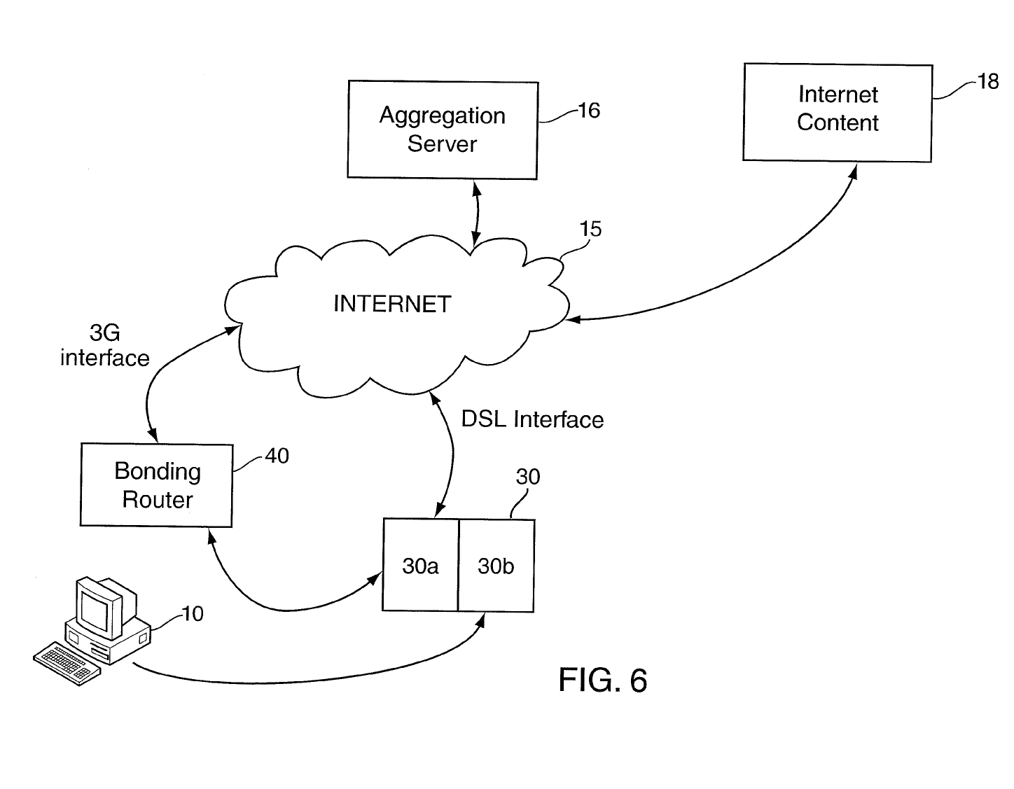

FIG. 6 illustrates the customer LAN device 10 connected to bonding router 40 and home gateway router 30 connected to the Internet 15 and in communication with the Aggregation Server 16. The home gateway router may be considered to comprise a core routing component 30a which is connected to the Internet 15 and a switching component 30b comprising the wired and wireless Ethernet switch portions connected via the Ethernet bridge. When data is sent by the Bonding Router 40 to the Internet 15 via the original gateway router 30 the core routing component 30a of the original gateway 30 is utilised. When a packet destined for an Internet service (for example Internet Content Server 18) is generated by a device 10 the MAC address required is determined from the ARP entry in the device's ARP table (which will now be the MAC address of the Bonding Router 40). The packet is therefore examined by switching component 30b and directed to the Bonding Router 40. The Bonding router 40 decides which of the available bonded lines to utilise to send the packet to the Internet 15. In the example shown the packet may be sent via a 3G connection or may be sent back through the original router 30 utilising the core routing component 30a. Packets sent via either route will be accumulated by the Aggregation Server 16 in the usual way.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable combination.

It is to be recognised that various alterations, modifications, and/or additions may be introduced into the constructions and arrangements of parts described above without departing from the invention as defined in the following claims.

1. A bonding router for receiving packets from a local area network and sending them over an aggregated link comprising a plurality of communication links in which the local area network has a default router and devices in the local area network have previously been configured to communicate with said default router using a network address associated with said default router; and
wherein the bonding router is arranged to obtain the network address of said default router and is arranged to regularly transmit a message to devices within said local area network to cause said devices to associate the network address of the default router with the link layer address of the bonding router such that data sent by said devices containing the network address of the default router will instead be directed to the bonding router.

2. A router according to claim 1, in which the bonding router is arranged to create a static entry in an address translation table in the bonding router associating the network address of the default router with the link layer address of the bonding router.

3. A router according to claim 1, in which the network address is an IP address.

4. A router according to claim 1, in which the link layer address is a MAC address.

5. A router according to claim 1, in which the network address of the default router is obtained using DHCP.

6. A router according to claim 1 in which said message comprises an ARP message.

7. A method of installing a bonding router in a local area network in which the local area network has a default router and devices in the local area network have previously been configured to communicate with said default router using a network address associated with said default router, the method comprising the steps of:
connecting the bonding router to the local area network;
obtaining the network address of the default router; and
regularly transmitting a message to devices within said local area network to cause said devices to associate the network address of the default router with the link layer address of the bonding router.

8. A method according to claim 7, in which the method further comprises the step of:
creating a static entry in an address translation table in the bonding router associating the network address of the default router with the link layer address of the bonding router.

9. A method according to claim 7, in which the network address is an IP address.

10. A method according to claim 7, in which the link layer address is a MAC address.

11. A method according to claim 7, in which the network address of the default router is obtained using DHCP.

12. A method according to claim 7 in which said message comprises an ARP message.

13. (canceled)

14. (canceled)

15. A router according to claim 2, in which the network address is an IP address.

16. A router according to claim 2, in which the link layer address is a MAC address.

17. A router according to claim 2, in which the network address is the default router is obtained using DHCP.

18. A router according to claim 2, in which said message comprises an ARP message.

19. A method according to claim 8, in which the network address is an IP address.

20. A method according to claim 8, in which the link layer address is a MAC address.

21. A method according to claim 8, in which the network address of the default router is obtained using DHCP.

22. A method according to claim 8, in which said message comprises an ARP message.
